(19) United States
(12) Patent Application Publication
(10) Pub. No.: US 2025/0279996 A1
(43) Pub. Date: Sep. 4, 2025

(54) METHODS AND SYSTEMS FOR FACILITATING VERIFICATION OF A SERVICE PROVIDER

(71) Applicant: MSP Process, LLC, Madisonville, LA (US)

(72) Inventors: Patrick Leonard, Madisonville, LA (US); Greg Celmainis, North Vancouver (CA)

(21) Appl. No.: 19/070,193

(22) Filed: Mar. 4, 2025

Related U.S. Application Data
(60) Provisional application No. 63/561,091, filed on Mar. 4, 2024.

(51) Int. Cl. H04L 9/40

(52) U.S. Cl. CPC H04L 63/0838

(57) ABSTRACT

The present disclosure describes methods and systems for facilitating the verification of a service provider (SP) by an end user (EU). The disclosed system allows an EU, which may be a person, system, or company, to verify the legitimacy of an SP or SP personnel before granting access to sensitive information or systems. The system supports multiple verification mechanisms, including SMS, email, and client portals, to ensure secure and reliable verification. The verification process involves the exchange of randomly generated codes between the EU and SP, which must match to confirm the SP's identity. The system also includes features for logging verification requests and responses, integrating with service desk platforms, and providing multi-factor authentication (MFA) to enhance security.

The current application claims a priority to the U.S. Provisional Patent application Ser. No. 63/561,091 filed on Mar. 4, 2024.

### FIELD OF THE INVENTION

The present invention relates generally to data processing. More specifically, the present invention is methods and systems for facilitating verification of a service provider.

### BACKGROUND OF THE INVENTION

The field of data processing is technologically important to several industries, governments, business organizations, and/or individuals.

Enterprises or individuals (collectively referred as to as End-Users or “EU)” recently have been burned by Threat Actors (“TA”) who pose as an authority representative from a government, bank, telecom provider, IT service provider, or any other service provider (collectively referred to as Service Providers or “SP”). The threat actors try, through what is colloquially called voice phishing, to pry information from the EU which might enable them to compromise EU's enterprise systems, data, bank accounts, etc.

Typically, the systems available today provide a mechanism for the SP to verify the EU when the EU requests service from the SP. However, when a purported or a valid SP tries to contact an EU, existing techniques for verification of an SP by an EU are deficient. With rampant threat attempts by TAs to the vulnerable EU, where a TA may try to imitate the SP to gain access to a system, network or files, a simple-to-use mechanism whereby the EU can verify the validity of the SP is needed.

Therefore, there is a need for improved methods and systems for facilitating the verification of a service provider that may overcome one or more of the above-mentioned problems and/or limitations.

### SUMMARY OF THE INVENTION

This summary is provided to introduce a selection of concepts in a simplified form, which are further described below in the Detailed Description. This summary is not intended to identify key features or essential features of the claimed subject matter. Nor is this summary intended to be used to limit the claimed subject matter's scope.

Disclosed herein is a system for facilitating verification of a service provider, in accordance with some embodiments. Accordingly, the system may include a communication device configured for receiving a verification request associated with a service provider from at least one user device associated with at least one user. Further, the verification request may indicate that at least one user is suspicious of at least one service provider. Further, the verification request may include at least one service provider information associated with at least one service provider. Further, the communication device may be configured for transmitting a verification prompt to a trusted entity device associated with a trusted entity over a second communication channel. Further, the trusted entity device may include a smartphone, a tablet, a laptop, etc. Further, in some embodiments, the trusted entity device may include a server. Further, the trusted entity device may be configured for transmitting the verification prompt to a service provider device associated with at least one service provider. Further, the trusted entity device may be configured for receiving a response corresponding to the verification prompt from the service provider device associated with at least one service provider. Further, the communication device may be configured for receiving the response from the trusted entity device. Further, the communication device may be configured for transmitting the response to at least one user device. Further, the system may include a processing device configured for generating the verification prompt based on the verification request.

Further disclosed herein is a method for facilitating verification of a service provider, in accordance with some embodiments. Accordingly, the method may include receiving, using a communication device, a verification request associated with a service provider from at least one user device associated with at least one user. Further, the verification request may indicate that at least one user is suspicious of at least one service provider. Further, the method may include generating, using a processing device, a verification prompt based on the verification request. Further, the method may include transmitting, using the communication device, the verification prompt to a trusted entity device associated with a trusted entity over a second communication channel. Further, the trusted entity device may be configured for transmitting the verification prompt to a service provider device associated with at least one service provider. Further, the trusted entity device may be configured for receiving a response corresponding to the verification prompt from the service provider device associated with at least one service provider. Further, the method may include receiving, using the communication device, the response from the trusted entity device. Further, the method may include transmitting, using the communication device, the response to at least one user device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating verification of a service provider, in accordance with some embodiments.

FIG. 3 is a flow chart of a method for facilitating verification of a service provider, in accordance with some embodiments.

FIG. 4 is a flow chart of a method for facilitating verification of a service provider, in accordance with some embodiments.

FIG. 5 is a flow diagram of a method for facilitating verification of the service provider, in accordance with some embodiments.

FIG. 6 is a screenshot of a user interface of a software platform associated with the system for facilitating verification of the service provider, in accordance with some embodiments.

FIG. 7 is a screenshot of a user interface of the software platform associated with the system for facilitating verification of the service provider, in accordance with some embodiments.

FIG. 8 is a screenshot of a user interface of the software platform associated with the system for facilitating verification of the service provider, in accordance with some embodiments.

FIG. 9 is a screenshot of a user interface of the software platform associated with the system for facilitating verification of the service provider, in accordance with some embodiments.

FIG. 10 is a flow diagram of a method for facilitating verification of the service provider, in accordance with some embodiments.

FIG. 11 is a flow diagram of a method for facilitating verification of the service provider, in accordance with some embodiments.

FIG. 12 is a flow diagram of a method for facilitating verification of the service provider, in accordance with some embodiments.

FIG. 13 is a screenshot of a user interface of the software platform associated with the system for facilitating verification of the service provider, in accordance with some embodiments.

FIG. 14 is a screenshot of a user interface of the software platform associated with the system for facilitating verification of the service provider, in accordance with some embodiments.

FIG. 15 is a screenshot of a user interface of the software platform associated with the system for facilitating verification of the service provider, in accordance with some embodiments.

FIG. 16 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating verification of a service provider, embodiments of the present disclosure are not limited to use only in this context.

### Overview

The present disclosure describes methods and systems for facilitating verification of a service provider. Further, the disclosed system may be configured for allowing an EU (or End user) to verify a SP or a SP personnel. Further, the EU may be a person, end user, system, or company that wishes to verify the SP (or service provider). The purpose of technician verification is for an EU to verify that a SP is legitimate before allowing access to their computer systems or providing sensitive information that is in possession of the EU.

Further, the disclosed system may support several mechanisms for the EU (customer side) to verify the SP (Support Resource calling the client). The client may initiate a verification via a known code, to a known Destination Address (“DA”), which is a phone number or email address) provided to them from the disclosed system by their SP in advance of the call as part of their operating processes. This DA may be used by the client to send in a verification message such as #verify to the SP DA that may be assigned during setup process. Once the message is received by the system it processes it and pops up a message on the technician side so the technician may verify their identity to the EU. Further, the disclosed system may allow the SP to verify themselves to the EU via SMS or email:
1. The technician may send a simple message back to the user over the same SMS channel or to the same email address that initiated the request.
2. Each party is sent, to their respective devices, the same randomly generated code (the size of the code is irrelevant). The SP technician must provide, via the voice-call, their version of the code to the EU so that the EU can compare the code to the one that had been received by the EU. If the code provided by the SP to the EU matches the one received by the EU, the EU at their discretion can initiate the Confirmation sequence. SP Process also provides a client portal experience for SPs to provide their EUs (Customers). The customer or client may initiate a request to verify the technician from their client portal or SP Client Portal Mobile app to verify the technician's identity that way through a secure end-to-end verification process. The Customer (EU) may open the portal provided by the SP and initiate a request to verify the technician who is calling or emailing them. The user may have a “Verify Technician” button on their portal to select. Once they select it the system will send the secure request to the IT provider's Technician console and the technician can click Confirm. There are two options once the Technician clicks confirm:
1. Once they click to confirm the user, the EU (Customer or client) may receive a pop-up in their client portal showing that the technician has successfully verified themselves.
2. The Client and Technician (tech) may both receive a randomly generated code that each side receives on their portal that must match and is read to the EU via the technician.

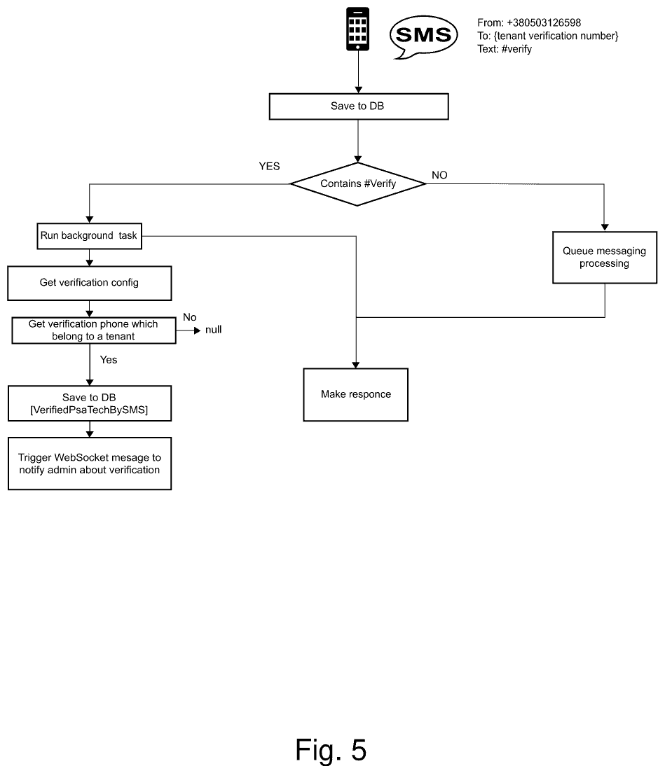

Further, as shown in FIG. 5, the system may receive a request from a contact for verification.

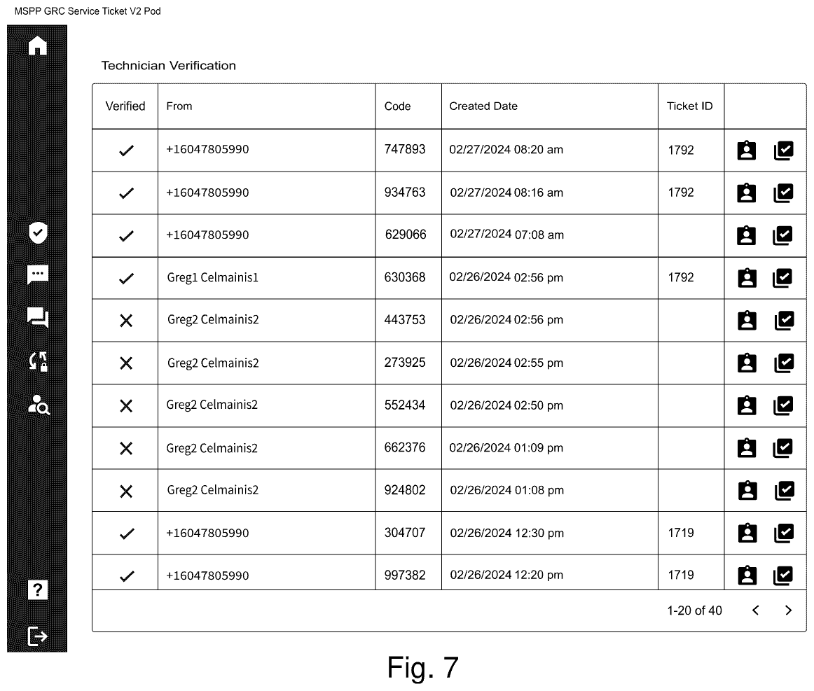

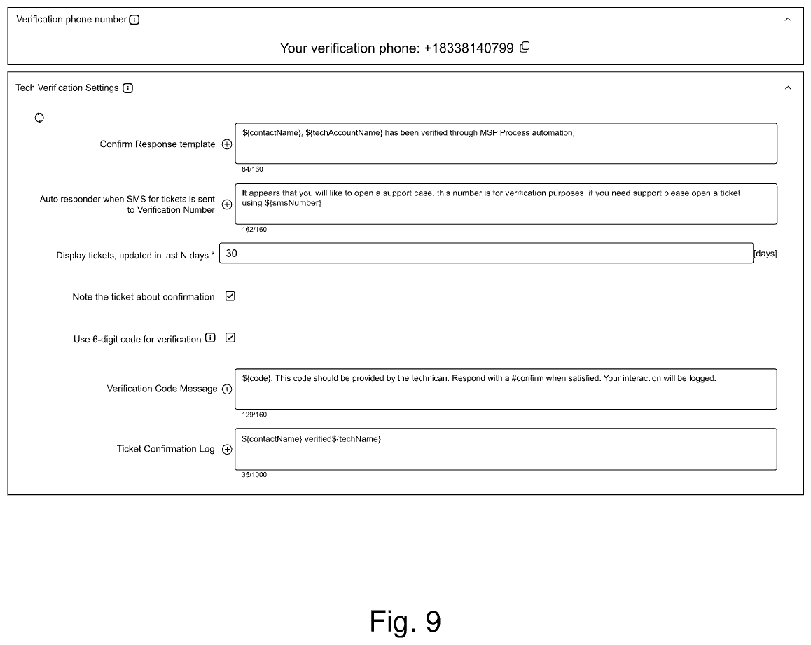

Further, as shown in FIG. 7, an admin may receive a verification request on the screen or at the POD. During the confirmation process, the technician opens a window with information about the user and the ability to send an SMS back. Further, as shown in FIG. 9, the response message may be configured in Verification→Verification Settings.

Further, the technician may use template variables to substitute the contact name and his name in the SMS message. The second step of verification is to attempt to find the PSA contact by its phone number. Further, the technician may select PSA integration to provide access to the search engine. (If the tenant has only one integration-it will be selected automatically)

If contact is found—the system displays his name, company, and list of his tickets, updated in last {N} days. A number of days may be configured using Verification Configuration.

Further, the technician may open a ticket on PSA using a hyperlink on a ticket number or select one ticket. The ticket may be selected to make a note about technician verification (if a configuration allows a ticket notation).

Format of ticket note may be:

“[2023-11-01T12:00] Patrick James requested Tech verification which was confirmed by John Connor.”

After the SMS is scheduled for delivery, the status of the verification request becomes “Completed.”

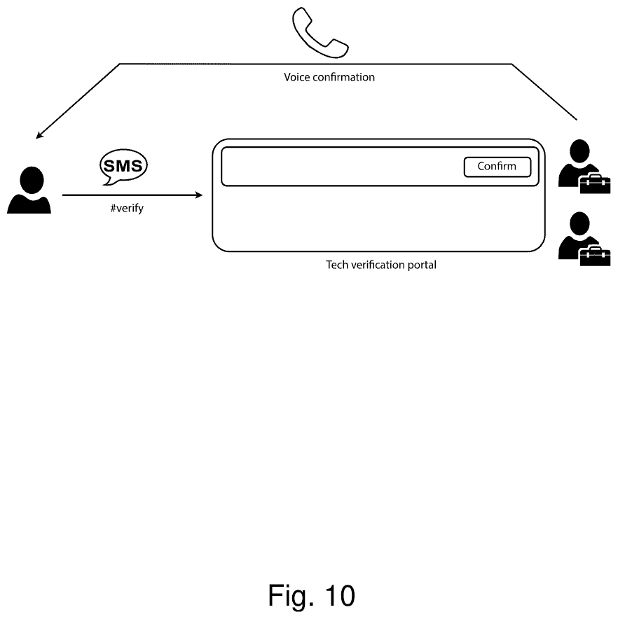

Further, in some embodiments, the system may verify the technician based on a simple verification request. Further, as shown in FIG. 10, the user sends a message to a verification number, the technician sees the message and provides verification manually.

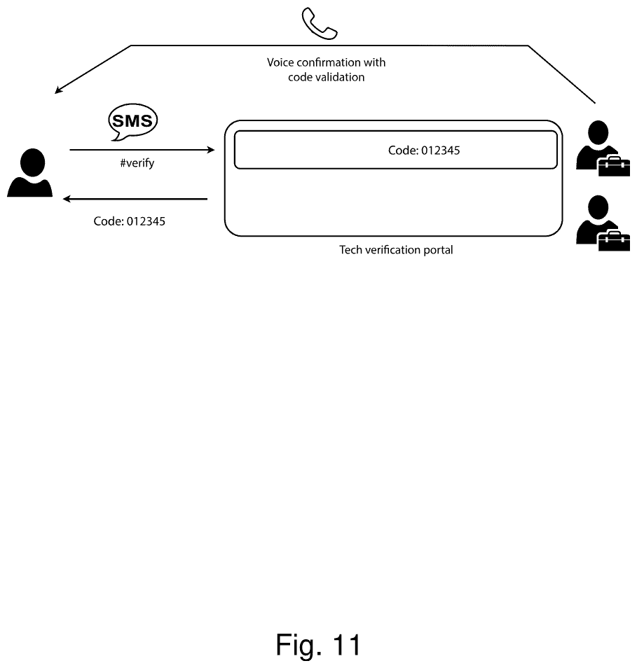

Further, in some embodiments, the system may verify the technician based on a code. Further, as shown in FIG. 11, the user sends a message to a verification number and receives the verification code, the technician sees the message, confirms the code to a user, and provides verification manually.

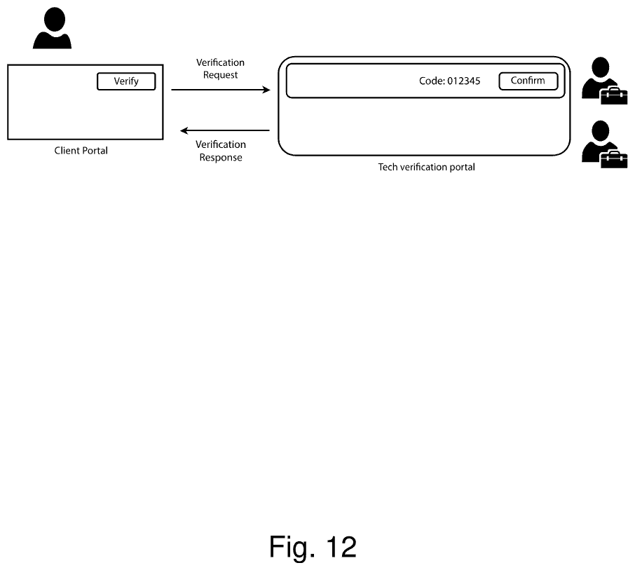

Further, in some embodiments, the system may verify the technician using a client portal. Said client portal may be Teams, Slack, or any other similar platform for group communication. Further, as shown in FIG. 12, the user opens the client portal and sends a verification request. The technician confirms the request, and the user sees the response. Further, the user may poll a list of technicians from the client portal, and then click on the technician the user wishes to verify. The technician and user then each receive a code which the technician may read back to the user to verify. Further, the verification request may be conducted through an authenticator app, removing the need for the user and technician to exchange codes in order to verify the technicians identity.

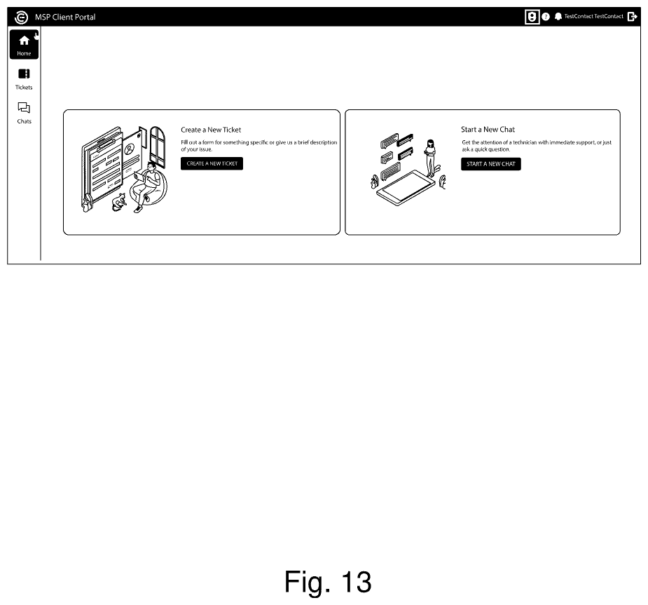

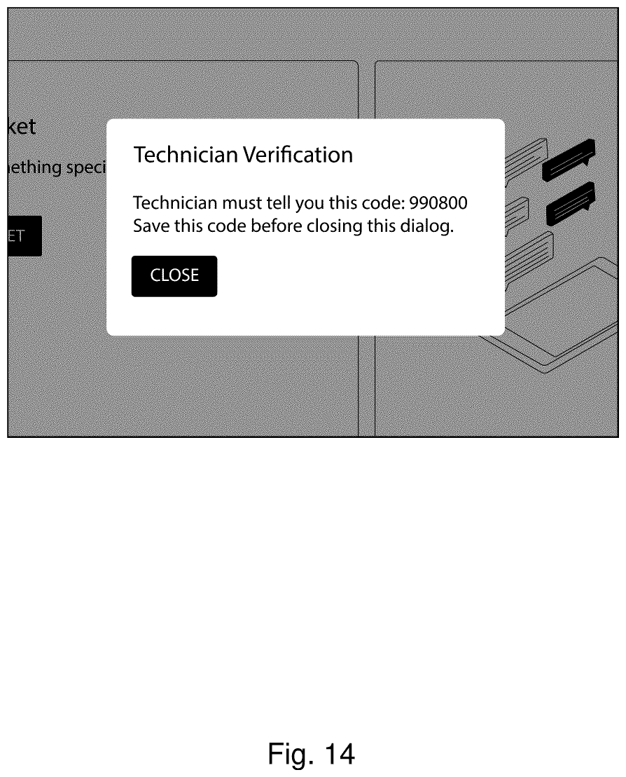

Further, in some embodiments, as shown in FIG. 13, the contact requests a verification. Further, as shown in FIG. 14, the contact can see the verification code.

Further, the contact may close this sub-window. Confirmation may appear in another one. Further, the technician sees a verification request. Further, the technician confirms the verification request. Further, the technician may select a ticket to save verification logs (if configured). To confirm verification, the technician may provide a security code to the client, mark the checkbox and press send. Further, the contact may receive a verification confirmation.

The goal of identity verification is to ensure that the person claiming a particular identity is, indeed, who they say they are. Verification, to be effective, relies on Multi-Factor Authentication (MFA). Further, a list of factors to rely on may include:
Something You Know: This involves knowledge-based factors such as passwords, PINs, or security questions. Often these are not available at the time of authentication because of forgotten information. They can often be compromised because they are often shared or based upon easily generated information (birth dates, addresses or less.)
Something You Have: This includes possession-based factors such as security tokens, smart cards, or mobile devices. In the case of a mobile device, this usually means the phone number and possession of the device as forms of authentication because you can reference them via a phone call, SMS, or an application notification push.

Something You Are: This involves biometric factors like fingerprints, facial recognition, or retina scans. With access to the mobile devices, biometric information authenticated and stored on the device is proof of something that is unique to the EU.

SMS send-Further, EUV pushes a 6-digit code or a single-click link to a mobile device (Something you Have). Since the EU has supplied the phone number (Something you Know) of the mobile device that relies on a PIN, Password (Something you know), or a biometric (Something you Are) to access the device, there may be three levels of authentication in place.

Email send—as above, the EUV pushes the 6-digit code or single-click link to a known email address. The email box may be authenticated by the physical access to the mobile or desktop device AND to the email client.

Client Portal or Client App—in the event that the user doesn't have access to SMS or email or it is more convenient to do so, the user (or the EU) may access either the Client Portal with a password (Something You Know) or the Client App with a biometric login (Something you Are). Once the EU has accessed the Portal or App, the technician may push a code or a confirmation request for the EU to complete the Verification.

Often threat actors may pose as a technician from a service desk in an attempt to gain access to network, servers, or other network applications. They often sound credible because the actors may have obtained some pertinent or meaningful information that can be used to fool the user or the EU into believing that you are speaking with a technician from the SP service desk.

Tech Verification is a simple, thirty second process. The EU sends #verify using SMS on their mobile (Something you have) number to published Verification phone number (Something you know). Further, the published Verification phone number may be associated with the disclosed system. In response to this, the user may be provided with aa unique 6-digit code that only you and a valid service technician from a service desk may know. When the technician provides this code to the user, and the user may be satisfied that it is correct, you send #confirm on SMS back to the Verification phone number.

_>Stop—the information above can probably be removed with little loss of importance to the patent app.

Enterprises or individuals (collectively referred as to as EUs or “EU)” recently have been burned by Threat Actors (“TA”) who pose as an authority representative from a government, bank, telecom provider, IT service provider, or any other service provider (collective referred to as Service Providers or “SP”). They try, through what is colloquially called voice phishing, to pry information from the EU which might enable them to compromise EU's enterprise systems, data, bank accounts, etc. In Further, the disclosed system may allow enterprises or individuals to verify that any voice call requests can be verified as legitimate or a threat.

Further, the disclosed system may facilitate training the EU to have no trust for any incoming phone call from any SP seeking proprietary information. The EU may be instructed to initiate a verification sequence to validate that the request is from a legitimate entity at the SP. This provides confidence because it is achieved through multi-factors, all of which are only known by the two participating and valid entities-the SP and the EU.

There is always prior information known only by each entity. In the case of the SP, the SP may know the phone number, email address, or that the EU is a valid registered user of a Customer Portal (“CP”) provided by the SP. The EU may know of the SP-provided phone number, email address, or CP. The CP is protected by a User ID/Password (“UIP”) sequence.

No matter what medium is used for verification-SMS, email, customer portal—the process for the verification follows a similar procedure. There is always something that is known between the two parties that is not generally published for public consumption such as an SMS phone number (“SPN”), Private email address (“PEA”), or a customer portal (“CP”) with a UserID/Password (“UIP”) login sequence.

The sequence may be as follows:
1) The SP has reason to contact the EU, and this is done through a voice call to the EU. The SP may be IT SP responding to a service request ticket, or a bank looking for confirmation on a potentially fraudulent transaction.
2) The agreed upon policy between the SP and the EU is that the verification procedure may be initiated for any call between the SP and the EU
3) The EU, using the agreed upon medium (SMS on a mobile device, an email on mobile, laptop or computing device, or a web-based customer portal accessed by any of the above devices), the EU starts the verification request (“VR”) by sending a Verify Code (“VC”), #verify for example, to a pre-agreed but private SPN, or a pre-agreed PEA. In these cases, the VC must be initiated from an EU email address or phone number known by the SP. In the case of the CP, the EU logs into the CP the UIP, and clicks on a Verify button within the CP.
4) Any of the above Verify commands initiate a sequence of events within disclosed VS that may be completed when the EU has been satisfied that the SP has been verified or can reject the verification. In the event that the VR comes from an unknown phone number or email address, the VR may not be initiated. However, all VR will be logged for compliance and historical recall.
a. The VS may generate a random number (usually six digits, but could be any number) that will be
i. Sent back to the EU through the medium from where the VR originated and to the respective email address or phone number that originated the VR. In the case of CP-originated VR, the code will be pushed to a banner with an appropriate message and this associated code. The message may read something thing like “The verification code ‘012345’ should be provided by the SP”.
ii. Provided to the SP in an SP console with a message that may read something like “Please provide code ‘012345’ to the EU.
b. The SP may provide the code to the EU via the phone call.
c. If the EU is satisfied that the SP has provided the corresponding matching code:
i. the EU may give a verbal confirmation to the SP that they are satisfied with the legitimacy of the SP and continue the phone call.
ii. the EU may send a Confirmation Code (“CC”), #confirm for example, to the SPN or the PEA. In the case of the CP, the EU would click on the “Confirm” button within the CP.
d. If the EU is not satisfied that the SP has provided the matching code the EU may:
i. Hang-up the phone
ii. Re-initiate the VR
5) There are some ancillary functions of the VR that can be considered in specific applications. In the event that the SP has a service or help desk platform, the entire sequence of events (VR, and corresponding response) can be logged within a service ticket for posterity when the Verification Sequence has been completed. This could be automatic or at the approval of the SP personnel.

Further, in some embodiments, the admin/tech should be able to initiate from a computer, and/or a mobile app.

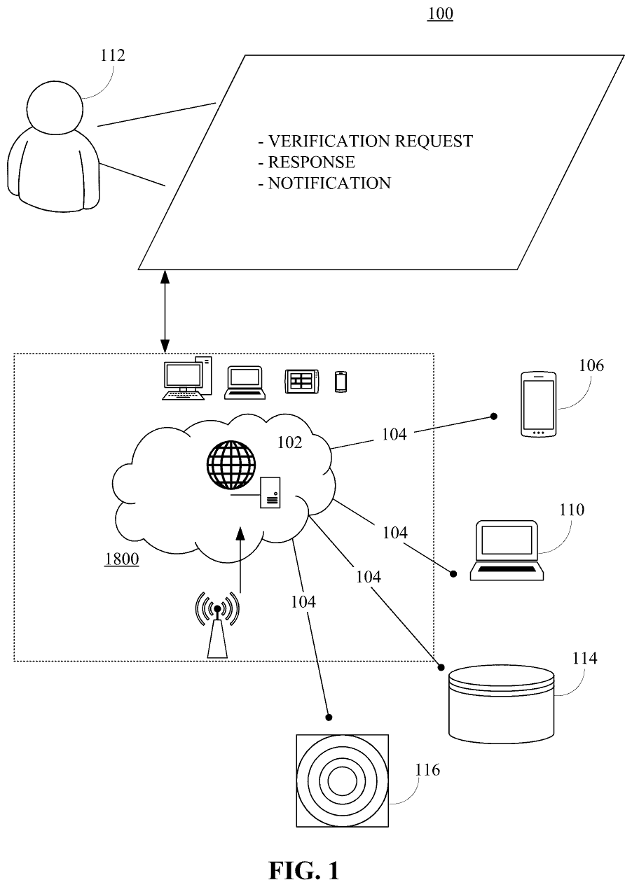

FIG. 1 is an illustration of an online platform 100 consistent with various embodiments of the present disclosure. By way of non-limiting example, the online platform 100 for verification of a service provider may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, service providers, service receivers, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 1800.

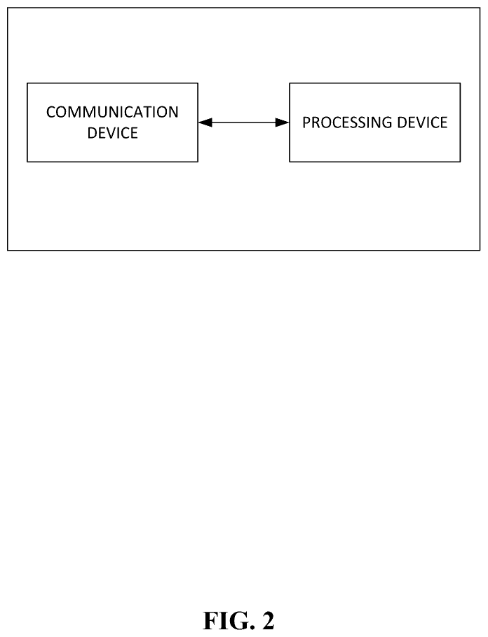

FIG. 2 is a block diagram of a system for facilitating verification of a service provider, in accordance with some embodiments. Accordingly, the system may include a communication device configured for receiving a verification request associated with a service provider from at least one user device associated with at least one user. Further, the verification request may indicate that at least one user is suspicious of at least one service provider. Further, the verification request may include at least one service provider information associated with at least one service provider. Further, at least one service provider information may include a service provider name, an email address, an identification number, etc. Further, the verification request may include at least one user information associated with at least one user. Further, at least one user information may include a username, an email address, a user identification number, etc. Further, at least one user may communicate to at least one service provider over a first communication channel.

Further, the communication device may be configured for transmitting a verification prompt to a trusted entity device associated with a trusted entity over a second communication channel. Further, the trusted entity device may include a smartphone, a tablet, a laptop, etc. Further, in some embodiments, the trusted entity device may include a server. Further, the trusted entity device may be configured for transmitting the verification prompt to a service provider device associated with at least one service provider. Further, the trusted entity device may be configured for receiving a response corresponding to the verification prompt from the service provider device associated with at least one service provider. Further, the communication device may be configured for receiving the response from the trusted entity device. Further, the communication device may be configured for transmitting the response to at least one user device.

Further, the system may include a processing device configured for generating the verification prompt based on the verification request.

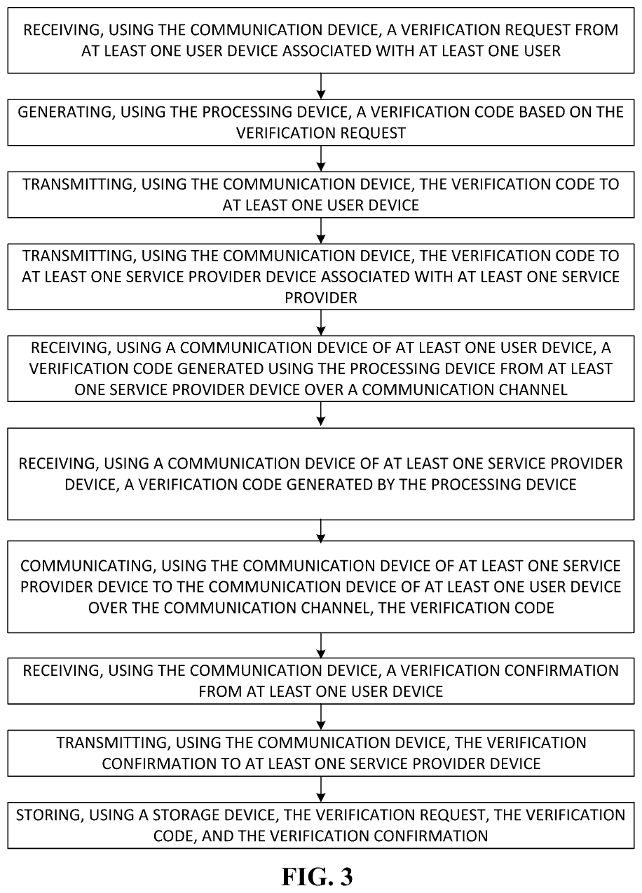

FIG. 3 is a flow chart of a method for facilitating verification of a service provider, in accordance with some embodiments. Accordingly, the method may include receiving, using the communication device, a verification request from at least one user device associated with at least one user. Further, the verification request may indicate that at least one user is suspicious of the identity of at least one service provider. Further, at least one user may be suspicious of an activity, a text, a speech, etc. performed by at least one user. Further, the verification request may include at least one service provider information associated with at least one service provider. Further, at least one service provider may include an individual, an institution, and an organization that may want to provide at least one service (or technical service/assistance) to at least one user. Further, in an instance, at least one service provider may be a technical service provider. Further, at least one service provider information may include a service provider name, an email address, an identification number, etc. Further, the verification request may include at least one user information associated with at least one user. Further, at least one user information may include a username, a user email address, a user identification number, a user phone number, etc. Further, the verification request may be received over a first communication medium based on a trusted entity contact information. Further, the trusted contact information may be published in public domain. Further, the trusted contact information may be available or published in public domain. Further, the trusted contact information may be a contact number, an email address, etc. Further, the first communication medium may be one of a phone call, an email, a text message, etc. Further, in an instance, the first communication medium may include SMS on a mobile device, an email on a mobile, a laptop/computing device, or a web-based customer portal (CP) accessed by any of the above devices. Further, in an instance, the first communication medium may include a mobile app with a mobile interface. Further, in an instance, the verification request may include an indication (comprising a text such as #verify) that may indicate that at least one user may want to verify the identity of at least one service provider.

Further, the method may include generating, using the processing device, a verification code based on the verification request. Further, the verification code may be a random number comprising at least one of at least one digit, at least one alphabet, and at least one special character. Further, in an instance, the verification code may be “012345”.

Further, the method may include transmitting, using the communication device, the verification code to at least one user device. Further, the verification code may be transmitted using the first communication medium to at least one user device based on at least one of the user email addresses and the user phone number.

Further, the method may include transmitting, using the communication device, the verification code to at least one service provider device associated with at least one service provider. Further, the verification code may be transmitted to at least one service provider device using at least one service provider information.

Further, the method may include receiving, using a communication device of at least one user device, a verification code generated using the processing device from at least one service provider device over a communication channel. Further, the communication channel may be a telephonic call, a Wi-Fi call, a text message, etc. Further, the verification code may include a code provided by at least one service provider to verify the identity of at least one service provider.

Further, the method may include receiving, using a communication device of at least one service provider device, a verification code generated by the processing device.

Further, the method may include communicating, using the communication device of at least one service provider device to the communication device of at least one user device over the communication channel, the verification code.

Further, the method may include receiving, using the communication device, a verification confirmation from at least one user device. Further, the verification confirmation may indicate if at least one service provider is genuine. Further, the verification confirmation may indicate a trust level of at least one user for at least one service provider. Further, in an instance, the verification confirmation may include a text such as #confirm.

Further, the method may include transmitting, using the communication device, the verification confirmation to at least one service provider device.

Further, the method may include storing, using a storage device, the verification request, the verification code, and the verification confirmation.

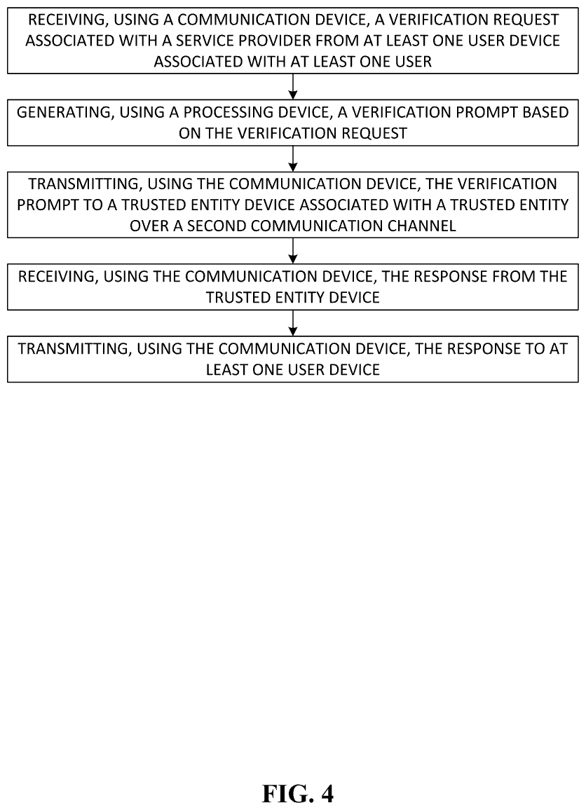

FIG. 4 is a flow chart of a method for facilitating verification of a service provider, in accordance with some embodiments. Accordingly, the method may include receiving, using a communication device, a verification request associated with a service provider from at least one user device associated with at least one user. Further, the verification request may indicate that at least one user is suspicious of at least one service provider. Further, at least one user may be suspicious of an activity, a text, a speech, etc. performed by at least one user. Further, the verification request may include at least one service provider information associated with at least one service provider. Further, at least one service provider information may include a service provider name, an email address, an identification number, etc. Further, the verification request may include at least one user information associated with at least one user. Further, at least one user information may include a username, an email address, a user identification number, etc. Further, at least one user may communicate with at least one service provider over a first communication channel.

Further, the method may include generating, using a processing device, a verification prompt based on the verification request.

Further, the method may include transmitting, using the communication device, the verification prompt to a trusted entity device associated with a trusted entity over a second communication channel. Further, the trusted entity device may include a smartphone, a tablet, a laptop, etc. Further, in some embodiments, the trusted entity device may include a server. Further, the trusted entity device may be configured for transmitting the verification prompt to a service provider device associated with at least one service provider. Further, the trusted entity device may be configured for receiving a response corresponding to the verification prompt from the service provider device associated with at least one service provider.

Further, the method may include receiving, using the communication device, the response from the trusted entity device.

Further, the method may include transmitting, using the communication device, the response to at least one user device.

Further, in some embodiments, the method may include receiving, using the communication device, at least one communication data from at least one user device in real-time. Further, at least one communication data may include a call data, at least one message, etc. Further, the call data may include audio of a call between at least one user and at least one service provider.

Further, the method may include analyzing, using the processing device, at least one communication data using a machine learning model. Further, at least one machine learning model may include a natural language processing model.

Further, the method may include determining, using the processing device, an intent based on the analyzing of at least one communication data.

Further, the method may include determining, using the processing device, a suspicion level corresponding to the intent based on the analyzing of at least one communication data.

Further, the method may include comparing, using the processing device, the suspicion level with a threshold suspicion level.

Further, the method may include generating, using the processing device, a notification based on the comparing. Further, the generating of the verification prompt may be based on the generating of the notification.

Further, the method may include transmitting, using the communication device, the notification to at least one user device.

Further, in some embodiments, the method may include receiving, using the communication device, at least one sensor data from at least one sensor. Further, at least one sensor be configured for generating at least one sensor data based on detecting at least one physiological parameter of at least one user. Further, at least one physiological parameter may include a heart rate, an oxygen saturation level, a blood pressure, etc.

Further, the method may include analyzing, using the processing device, at least one sensor data using a machine learning model.

Further, the method may include determining, using the processing device, an emotional state of at least one user based on the analyzing of at least one sensor data.

Further, the method may include determining, using the processing device, a trust level of at least one user towards at least one service provider based on the analyzing of at least one communication data.

Further, the method may include comparing, using the processing device, the trust level with a threshold trust level.

Further, the method may include generating, using the processing device, a suspicion notification based on the comparing of the trust level with the threshold trust level. Further, the suspicion notification may indicate a realization of at least one suspicious act performed by at least one service provider by at least one user. Further, the generating of the verification prompt may be based on the generating of the suspicion notification.

FIG. 5 is a flow diagram of a method for facilitating verification of the service provider, in accordance with some embodiments. Accordingly, the method may include receiving a message from a client device. Further, the method may include checking if the message includes “#verify.” Further, if the message does not include “#verify,” the method may include making a response. Further, the if the message includes “#verify”, the method may include running a background task. Further, the method may include receiving a verification configuration. Further, the method may include receiving a verification phone which may belong to a tenant. Further, if the verification phone is received, the method may include saving at least one of the messages and a verification result to a database. Further, the method may include triggering a WebSocket message to notify an admin about the verification. Further, the method may lead to making the response after running the background task.

Accordingly, the EU receives the same prompt as the SP personnel may receive, such as a code that is only known between the legitimate SP and the EU (because they each received it). The EU, at their discretion, determines that the SP has provided the proper code. If so, the EU can either initiate the CONFIRM response, that may either be CONFIRM response code, such as #Confirm on SMS channel or a CONFIRM response button that gets transmitted back to the SP.

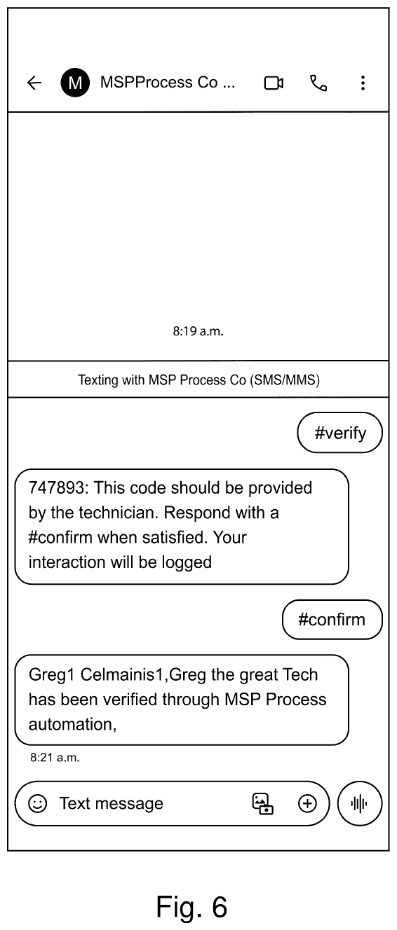

FIG. 6 is a screenshot of a user interface of a software platform associated with the system for facilitating verification of the service provider, in accordance with some embodiments. Accordingly, confirmation process may be completed from the disclosed portal or from SMS/Email etc. Further, the user may confirm that the provider confirmed their identity.

FIG. 7 is a screenshot of a user interface of the software platform associated with the system for facilitating verification of the service provider, in accordance with some embodiments.

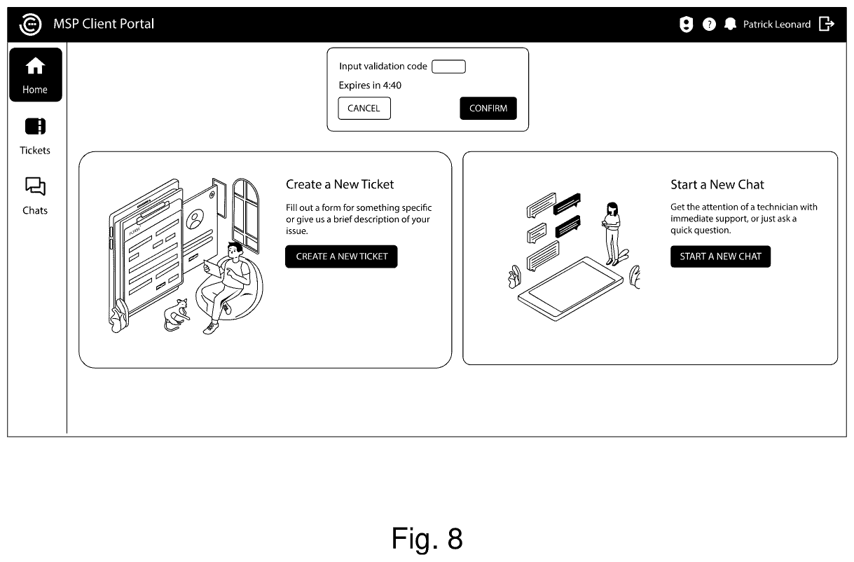

FIG. 8 is a screenshot of a user interface of the software platform associated with the system for facilitating verification of the service provider, in accordance with some embodiments.

FIG. 9 is a screenshot of a user interface of the software platform associated with the system for facilitating verification of the service provider, in accordance with some embodiments.

FIG. 10 is a flow diagram of a method for facilitating verification of the service provider, in accordance with some embodiments. Accordingly, the method may include the EU initiating the CONFIRM response by sending #confirm or within the App or Portal and hitting the CONFIRM button or putting in the code for confirmation.

FIG. 11 is a flow diagram of a method for facilitating verification of the service provider, in accordance with some embodiments.

FIG. 12 is a flow diagram of a method for facilitating verification of the service provider, in accordance with some embodiments.

FIG. 13 is a screenshot of a user interface of the software platform associated with the system for facilitating verification of the service provider, in accordance with some embodiments.

FIG. 14 is a screenshot of a user interface of the software platform associated with the system for facilitating verification of the service provider, in accordance with some embodiments.

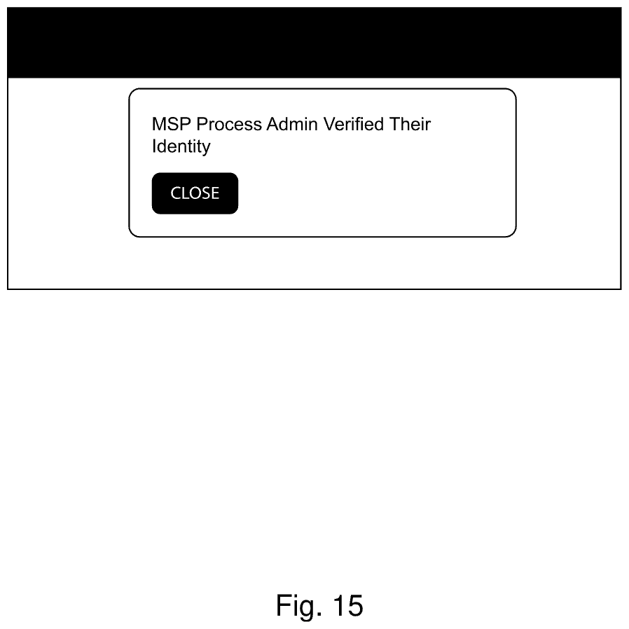

FIG. 15 is a screenshot of a user interface of the software platform associated with the system for facilitating verification of the service provider, in accordance with some embodiments.

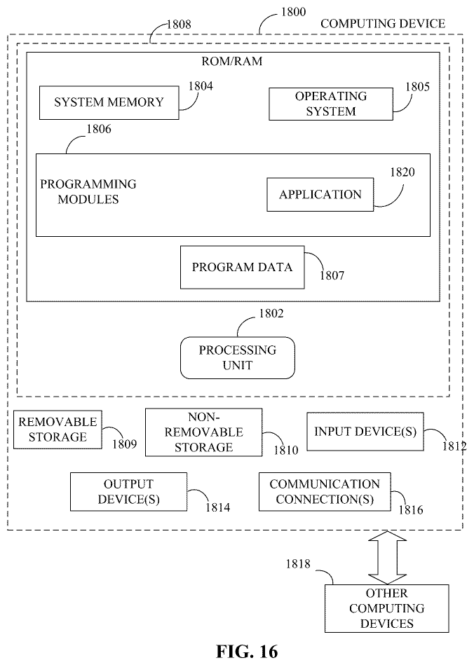

With reference to FIG. 16, a system consistent with an embodiment of the disclosure may include a computing device or cloud service, such as computing device 1800. In a basic configuration, computing device 1800 may include at least one processing unit 1802 and a system memory 1804. Depending on the configuration and type of computing device, system memory 1804 may comprise, but is not limited to, volatile (e.g., random-access memory (RAM)), non-volatile (e.g., read-only memory (ROM)), flash memory, or any combination. System memory 1804 may include operating system 1805, one or more programming modules 1806, and may include a program data 1807. Operating system 1805, for example, may be suitable for controlling computing device 1800's operation. In one embodiment, programming modules 1806 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 16 by those components within a dashed line 1808.

Computing device 1800 may have additional features or functionality. For example, computing device 1800 may also include additional data storage devices (removable and/or non-removable) such as, for example, magnetic disks, optical disks, or tape. Such additional storage is illustrated in FIG. 16 by a removable storage 1809 and a non-removable storage 1810. Computer storage media may include volatile and nonvolatile, removable and non-removable media implemented in any method or technology for storage of information, such as computer-readable instructions, data structures, program modules, or other data. System memory 1804, removable storage 1809, and non-removable storage 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1800. Any such computer storage media may be part of device 1800. Computing device 1800 may also have input device(s) 1812 such as a keyboard, a mouse, a pen, a sound input device, a touch input device, a location sensor, a camera, a biometric sensor, etc. Output device(s) 1814 such as a display, speakers, a printer, etc. may also be included. The aforementioned devices are examples and others may be used.

Computing device 1800 may also contain a communication connection 1816 that may allow device 1800 to communicate with other computing devices 1818, such as over a network in a distributed computing environment, for example, an intranet or the Internet. Communication connection 1816 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1804, including operating system 1805. While executing on processing unit 1802, programming modules 1806 (e.g., application 1820 such as a media player) may perform processes including, for example, one or more stages of methods, algorithms, systems, applications, servers, databases as described above. The aforementioned process is an example, and processing unit 1802 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method for facilitating verification of a services provider (SP) by an end user (EU), comprising;
receiving a verification request from an EU device, wherein the verification request includes SP information and EU information;
generating a verification code based on the verification request;
transmitting the verification code to the EU device and the SP device;
receiving a response from the SP device, wherein the response includes the verification code;
comparing the verification code received from the SP device with the verification code transmitted to the EU device; and
transmitting a verification confirmation to the EU device if the verification codes match.

2. The method of claim 1, wherein the verification request is initiated by the EU via SMS, email, or a client portal.

3. The method of claim 1, further comprising;
logging the verification request and response for compliance and historical recall.

4. The method of claim 1, wherein the verification code is a randomly generated number comprising at least one alphanumeric or special character.

5. The method of claim 1, further comprising;
integrating with a service desk platform to log the verification sequence within a service ticket.

6. A system for facilitating verification of a service provider (SP) by an end user (EU), comprising;
a communication device configured to receive a verification request from an EU device and transmit a verification code to the EU device and the SP device;
a processing device configured to generate the verification code based on the verification request; and
a storage device configured to store the verification request, verification code, and verification confirmation.

7. The system of claim 6, wherein the communication device is further configured to receive a response from the SP device and transmit a verification confirmation to the EU device if the verification codes match.

8. The system of claim 6, wherein the verification request is initiated by the EU via SMS, email, or a client portal.

9. The system of claim 6, further comprising;
a logging module configured to log the verification request and response for compliance and historical recall.

10. The system of claim 6, wherein the processing device is further configured to integrate with a service desk platform to log the verification sequence within a service ticket.
